(19) United States
(12) Patent Application Publication
(10) Pub. No.: US 2009/0281980 A1
(43) Pub. Date: Nov. 12, 2009

(54) LIFESTYLE IMPROVEMENT SUPPORTING APPARATUS AND LIFESTYLE IMPROVEMENT SUPPORTING METHOD

(76) Inventors: Yuko Taniike, Osaka (JP); Noriko Kenjou, Osaka (JP); Tatsurou Kawamura, Kyoto (JP)

Correspondence Address: WENDEROTH, LIND & PONACK L.L.P., 1030 15th Street, N.W., Suite 400 East, Washington, DC, 20005-1503, US

(21) Appl. No.: 12/096,824

(22) PCT Filed: Dec. 19, 2006
(86) PCT No.: PCT/JP2006/325265

§ 371 Date: Jun. 10, 2008

(30) Foreign Application Priority Data
Dec. 19, 2005 (JP) 2005-365447

(51) Int. Cl. G06Q 50/00; G06N 5/02

(52) U.S. Cl. 706/54; 705/3

(57) ABSTRACT

To provide a lifestyle improvement supporting apparatus and a lifestyle improvement supporting method which can offer appropriate advice corresponding to a performance state of lifestyle improvement carried out by a subject.

An objective information receiving unit (120) receives objective information (an average urinary sodium level of the current month) relating to a subject, from the subject (S301), and calculates a difference (=A) in the average values between the current month and the previous month. A test result receiving unit (110) receives a test value (a blood pressure value) of the subject from the subject (S302), and calculates a difference (=B) in the blood pressure value over one month. A test result judgment unit 130 evaluates a lifestyle improvement activity on the basis of the calculated values A and B. The lifestyle improvement activity is evaluated according to combinations (four patterns) of the differences A and B (S303), and then advice corresponding to the evaluation result is presented (S304 to S320).

### TECHNICAL FIELD

The present invention relates to a lifestyle improvement supporting technology whereby a measurement result of a physical quantity relating to a living subject is used so that advice or the like corresponding to a state of the subject is offered to support lifestyle improvement.

### BACKGROUND ART

In prevention and treatment of lifestyle-related diseases, an essential issue to be addressed in the future is to grasp a lifestyle ideal for a subject and provide guidance on improvement from a current lifestyle to the ideal lifestyle. Lifestyles having significant effects on inducing the lifestyle-related diseases include eating, lack of exercise, and alcohol drinking.

However, on a treatment setting of the lifestyle-related diseases, for example, it is difficult to precisely grasp the state of a patient undergoing medical treatment or a suspected patient (referred to as the “subject” hereafter) and to offer guidance on a lifestyle which is ideal for the individual.

Conventionally, in the case of hypertension for example, a blood pressure value which is a test value identifying the disease is checked for evaluating the lifestyle improvement method (or advice) used by the subject. Moreover, there is a system disclosed, whereby: the subject is clinically interviewed as to whether the lifestyle improvement activity could be carried out; a relation between a result of the clinical interview and a result of the test value is analyzed; the lifestyle improvement method or the like is evaluated; and then next advice is accordingly created (See Patent Reference 1, for example).

### Patent Reference 1: Japanese Unexamined Patent Application Publication No. 2004-326328

### DISCLOSURE OF INVENTION

### Problems that Invention is to Solve

Using the above-described evaluation method, however, the test value does not reflect the lifestyle. For this reason, it cannot be determined whether the test value is not improved because the lifestyle improvement activity is not carried out or because the lifestyle improvement activity itself is not effective for the subject. Thus, the problem is that the lifestyle improvement activity performed by the subject cannot be correctly evaluated.

Also, even in the case where the lifestyle improvement method or the like is evaluated on the basis of the result of the clinical interview, the lifestyle improvement activity of the subject cannot be correctly evaluated because, when trying to grasp the performance state of the lifestyle improvement of the subject through a question having an obvious intention, the subject would be aware of the intention of the question and give a false answer which does not correspond to the state of the subject, or because the lifestyle improvement method which the subject believes to be correct is not correct.

The present invention is conceived in view of the stated conventional problem, and an object of the present invention is to provide a lifestyle improvement supporting apparatus and a lifestyle improvement supporting method which can correctly evaluate a lifestyle improvement activity performed by the subject and offer appropriate advice corresponding to the performance state of the lifestyle improvement activity.

### Means to Solve the Problems

A lifestyle improvement supporting apparatus of the present invention includes: a test result receiving unit which receives a test result which is used for diagnosing a lifestyle-related disease of a subject; an objective information receiving unit which receives objective information which objectively represents a lifestyle of the subject; and an advice generation unit which generates advice corresponding to a combination of the received test result and the received objective information, the advice being used for improving the lifestyle.

With this configuration, it becomes possible to offer appropriate advice corresponding to the performance state of the lifestyle improvement activity of the subject.

Also, the lifestyle improvement supporting apparatus may further include: a subjective information receiving unit which receives subjective information subjectively representing a performance state of an activity performed by the subject to improve the lifestyle, wherein the advice generation unit further generates advice corresponding to a combination of the received test result, the received objective information, and the received subjective information, the advice being used for improving the lifestyle.

Moreover, the lifestyle-related disease may be hypertension; the test result may be a blood pressure value of the subject; the objective information may be a urinary sodium level of the subject; and the subjective information may be a result of a clinical interview given to the subject, and the advice generation unit may generate the advice corresponding to a combination of the blood pressure value, the urinary sodium level, and the result of the clinical interview, the blood pressure value and the urinary sodium level both being measured in a predetermined period of time.

Furthermore, the lifestyle improvement supporting apparatus may further include: a test information storage unit which stores the test result and the objective information, wherein the test result receiving unit reads a past test result stored in the test information storage unit, and calculates a difference based on a comparison between the received test result and the past test result, the objective information receiving unit reads past objective information stored in the test information storage unit, and calculates a difference based on a comparison between the received objective information and the past objective information, and the advice generation unit generates the advice corresponding to a combination of the difference in the test results and the difference in the objective information, the advice being used for improving the lifestyle.

Also, the lifestyle improvement supporting apparatus may further include: a test result judgment unit which judges, using the received test result, whether or not the lifestyle needs to be improved.

It should be noted here that the present invention can also be realized as: a lifestyle improvement supporting method including the characteristic components included in the lifestyle improvement supporting apparatus, as its steps; and a program which causes a computer, such as a personal computer, to execute these steps. It should be understood that such a program can be widely distributed via a recording medium such as a DVD and a transmission medium such as the Internet.

### EFFECTS OF THE INVENTION

The lifestyle improvement supporting apparatus and the lifestyle improvement supporting method of the present invention can offer appropriate advice corresponding to the performance state of the lifestyle improvement activity of the subject.

### BRIEF DESCRIPTION OF DRAWINGS

FIG. 1 is a block diagram showing a functional structure of a lifestyle improvement supporting apparatus according to a first embodiment of the present invention.

FIG. 2 is a flowchart showing a flow of processing performed by the overall lifestyle improvement supporting apparatus according to the first embodiment of the present invention.

FIG. 3 is a flowchart showing processing details of an initial program of FIG. 2.

FIG. 4 is a flowchart showing processing details of a practical program of FIG. 2.

FIG. 5 is a block diagram showing a functional structure of a lifestyle improvement supporting apparatus according to a second embodiment of the present invention.

FIG. 6 is a diagram showing categorized patterns of advice generated by the lifestyle improvement supporting apparatus according to the second embodiment.

FIG. 7 is a flowchart showing processing details of a practical program according to the second embodiment.

FIG. 8 shows an example of configuration of a lifestyle improvement supporting system that includes a mobile terminal and a lifestyle improvement supporting apparatus.

### NUMERICAL REFERENCES

100, 200, 330 lifestyle improvement supporting apparatuses
110 test result receiving unit
120 objective information receiving unit
130, 230 test result judgment units
140, 240 test information storage units
150, 250 advice information storage units
160, 260 advice generation units
170 advice presentation unit
210 subjective information receiving unit
300 lifestyle improvement supporting system
310 mobile terminal
320 network

### BEST MODE FOR CARRYING OUT THE INVENTION

The following is a detailed description of embodiments of the present invention, with reference to the drawings.

It should be noted that although the present invention is described with reference to the following embodiments and the accompanying drawings, these are examples and the present invention is not intended to be limited to these. For example, an explanation is given about a lifestyle improvement supporting apparatus which employs “a urinary sodium level” as an example of biological information that objectively represents a state of a lifestyle-related disease. However, a kind of biological information is not limited to the urinary sodium level.

Note that, in the present embodiments, a lifestyle-related disease refers to a disease which involves a lifestyle in its occurrence and development. Lifestyle-related diseases include hypertension, diabetes, and hyperlipidemia, for example. Lifestyles which are involved in the occurrences and developments of the lifestyle-related diseases include eating habits, exercise habits, relaxation, smoking, and alcohol drinking.

In diagnosing a lifestyle-related disease, a test value (a test result) of a test item based on a diagnostic standard developed for each lifestyle-related disease by academic societies or the like can be used. Test results used for diagnosing the lifestyle-related diseases include a blood pressure value, a blood sugar level, a hemoglobin A1c value, a total cholesterol value, an LDL cholesterol value, an HDL cholesterol value, and a triglyceride level. As the test result used for diagnosing hypertension, which is one of the lifestyle-related diseases, the highest and lowest blood pressure values can be used, for example.

In the present embodiments, objective information refers to information that objectively represents the lifestyle of the subject. As the objective information, biological information (vital sign), such as a urinary sodium level, that fluctuates depending on the lifestyle can be used. Moreover, the objective information may be information other than biological information, such as the number of walking steps the subject takes per day.

Furthermore, in the present embodiments, subjective information refers to a result of the subject's own evaluation regarding the performance state of an activity carried out to improve the lifestyle of the subject. The subjective information includes a result of an answer to a clinical question, such as a question regarding the performance state of the activity carried out by the subject to improve the lifestyle, for example.

### First Embodiment

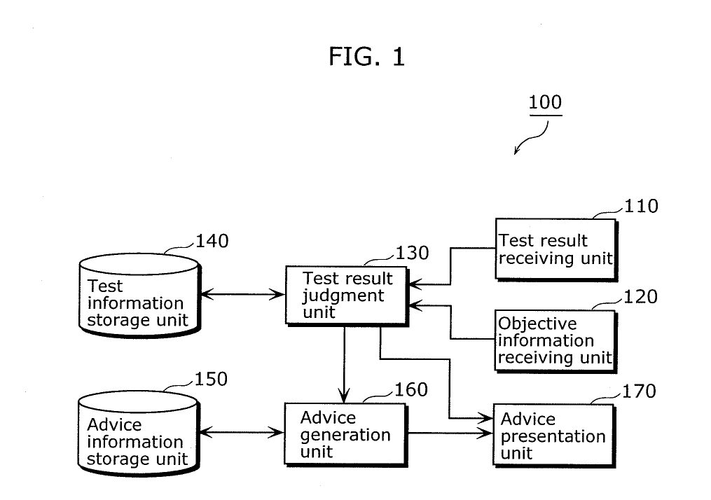

FIG. 1 is a block diagram showing a functional structure of a lifestyle improvement supporting apparatus 100 according to the present embodiment. The lifestyle improvement supporting apparatus 100 generates and provides advice, based on a test result (a blood pressure value, for example) used for diagnosing a lifestyle-related disease and on objective biological information (a urinary sodium level, for example) objectively representing a lifestyle. The lifestyle improvement supporting apparatus 100 includes a test result receiving unit 110, an objective information receiving unit 120, a test result judgment unit 130, a test information storage unit 140, an advice information storage unit 150, an advice generation unit 160, and an advice presentation unit 170.

The test result receiving unit 110 is a keyboard or a mouse, for example, and receives: information which shows the test result relating to the subject; and an instruction from the subject. Moreover, the test result receiving unit 110 reads a past test result stored in the test information storage unit 140, compares the received test result with the past test result, and then calculates a difference between these test results.

The objective information receiving unit 120 is a keyboard or a mouse, for example, and receives objective information relating to the subject. Moreover, the objective information receiving unit 120 reads past objective information stored in the test information storage unit 140, compares the received objective information with the past objective information, and then calculates a difference between these objective information pieces.

The test result judgment unit 130 is, for example, a microcomputer which includes a RAM and a ROM storing a control program, and controls the overall lifestyle improvement supporting apparatus 100. Moreover, the test result judgment unit 130 stores the received test result and the received objective information into the test information storage unit 140 in association with the subject. Furthermore, the test result judgment unit 130 reads, from the test information storage unit 140, data or the like needed for displaying a screen in order to receive the test result or the objective information via the test result receiving unit 110 or the objective information receiving unit 120, and sends the read data to the advice presentation unit 170.

The test information storage unit 140 is a hard disk drive, for example, and stores data in association with the subject, the data showing a name of a lifestyle-related disease (hypertension, diabetes, or hyperlipidemia, for example), a test item, and a test result. Moreover, the test information storage unit 140 stores a program and data for causing the advice presentation unit 170 to display a screen (such as an initial screen, a screen for receiving various kinds of data, or an advice presentation screen) according to an instruction from the test result judgment unit 130.

The advice information storage unit 150 is a hard disk drive, for example, and stores information needed for generating advice to be offered to the subject.

The advice generation unit 160 is, for example, a microcomputer which includes a RAM and a ROM storing a control program. On the basis of the test result received from the test result judgment unit 130, the advice generation unit 160 generates the advice to be offered to the subject, using the data stored in the advice information storage unit 150.

The advice presentation unit 170 is a liquid crystal display, for example, and presents the advice generated by the advice generation unit 160 to the subject.

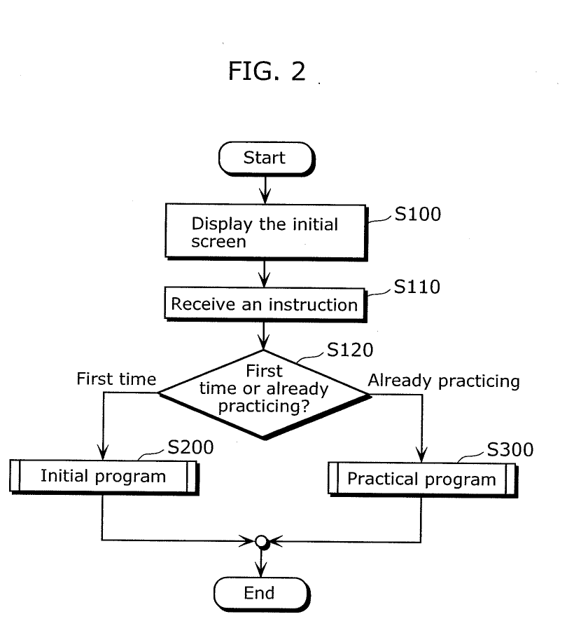

Next, an explanation is given about an operation performed by the lifestyle improvement supporting apparatus 100 configured as described above. FIG. 2 is a flowchart showing a flow of processing performed by the overall lifestyle improvement supporting apparatus 100.

First, the test result judgment unit 130 reads the data or the like for displaying the initial screen from the test information storage unit 140 and sends the read data to the advice presentation unit 170 (S100). As the initial screen, a screen for letting the subject select “Initial program” or “Practical program” is displayed. “Initial program” refers to a program initially selected by the subject who uses the present lifestyle improvement supporting apparatus 100, and provides advice as to whether or not the lifestyle needs to be improved and as to a course of action for improving the lifestyle. On the other hand, “Practical program” refers to a program selected by the subject who has already finished using “Initial program”, and provides effective advice while the lifestyle improvement is carried out.

Next, the test result receiving unit 110 receives an instruction to select “Initial program” or “Practical program” from the subject (S110), and notifies the test result judgment unit 130 of the instruction details. Following this, on the basis of the notified instruction details (S120), the test result judgment unit 130 reads the necessary data or the like from the test information storage unit 140 and executes the initial program (S200) or the practical program (S300).

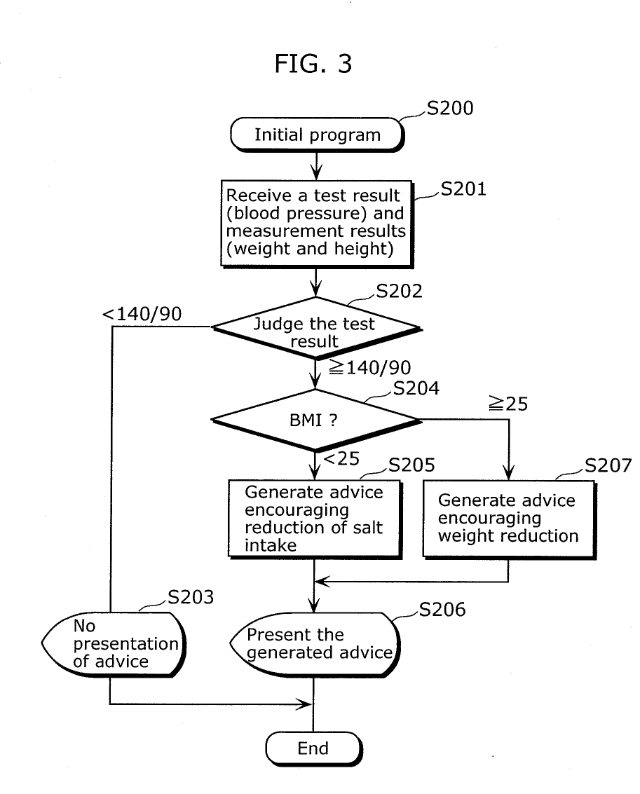

FIG. 3 is a flowchart showing processing details of the initial program (S200) of FIG. 2.

First, the test result receiving unit 110 receives the test result used for diagnosing a lifestyle-related disease from the subject and the measurement results including “weight” and “height” of the subject (S201), and sends the received results to the test result judgment unit 130.

Following this, the test result judgment unit 130 checks the received test result in reference to a predetermined standard value, and makes a judgment in relation to the lifestyle-related disease (S202). For example, when the judgment is made in relation to hypertension, the blood pressure value, which is the test result, is compared with the standard value of hypertension.

Accordingly, the judgment is made as to whether or not the subject has hypertension. To be more specific, when the highest blood pressure value/the lowest blood pressure value is 140/90 [mmHg] or higher, it is judged that the subject has hypertension. When the highest blood pressure value/the lowest blood pressure value is below 140/90 [mmHg], it is judged that the subject does not have hypertension. Thus, the advice presentation is not performed and the processing is ended (S203).

Next, when the highest blood pressure value/the lowest blood pressure value is 140/90 [mmHg] or higher so that the subject is judged to have hypertension, BMI (Body Mass Index) of the subject is first calculated (S204). BMI is a measure of obesity that is calculated by “weight [kg]/(height[m])²”. Whether the subject is obese or not is determined by whether BMI is “25” or higher. For example, suppose that the height is 175 cm and the weight is 70 [kg]. In this case, BMI is calculated as follows:

BMI=70/(1.75)²=22.9 [kg/m²] (1)

On this account, for the case of the subject whose BMI is “22.9”, (because BMI is below 25) it is judged that the subject is highly likely to have hypertension caused by a high intake of salt. Thus, “advice for encouraging salt intake reduction” is generated (S205). When BMI is “25” or higher, it is judged that the subject is highly likely to have hypertension caused by obesity. Thus, “advice for encouraging weight reduction” is generated (S207) and displayed by the advice presentation unit 170 (S206).

Here, an explanation is given about advice for hypertensive patients. As means of the lifestyle improvement to be carried out by a hypertensive patient, there are means of four categories: “salt intake reduction”, “weight reduction”. “exercise”, and “alcohol intake reduction”. These means are described in a hypertension guideline. Of these four means, “salt intake reduction” is a means effective for all hypertensive patients. For this reason, a first means taken to improve the lifestyle of the hypertensive patient is “salt intake reduction”. However, when the hypertensive patient is obese as well, it is said that it is more effective for the patient to start with “weight reduction”. On account of this, when the patient is judged to be hypertensive, it should be first judged whether the patient is obese or not. When the patient is obese as well, it is said that the patient should start with “weight reduction” as the means of highest priority to improve the lifestyle. Thus, when the patient is hypertensive but not obese, a first means taken to improve the lifestyle is “salt intake reduction”.

It should be noted that, of the above-mentioned four means, “alcohol intake reduction” is only for hypertensive patients who consume alcohol and therefore limits the subjects. On account of this, it is common to guide the subject through the lifestyle improvement in order of “exercise” and then “alcohol intake reduction”.

Because of the above reasons, the means of lifestyle improvement are ordered. Note that, for the subject in the present embodiment, “advice encouraging salt intake reduction” is generated and presented. Moreover, a description is added to the advice so as to encourage the measurement of a urinary sodium level, which is a measure objectively representing the effect of activity of “salt intake reduction” performed to improve hypertension.

After this, the subject performs the activity of “salt intake reduction” and measures the urinary sodium level as well. Then, after a predetermined period of time, the subject inputs the result into the lifestyle improvement supporting apparatus 100. “A predetermined period of time” is a month in this case here, as an example. This is because it is often the case that, when the subject is an outpatient, the subject visits hospital once or so a month.

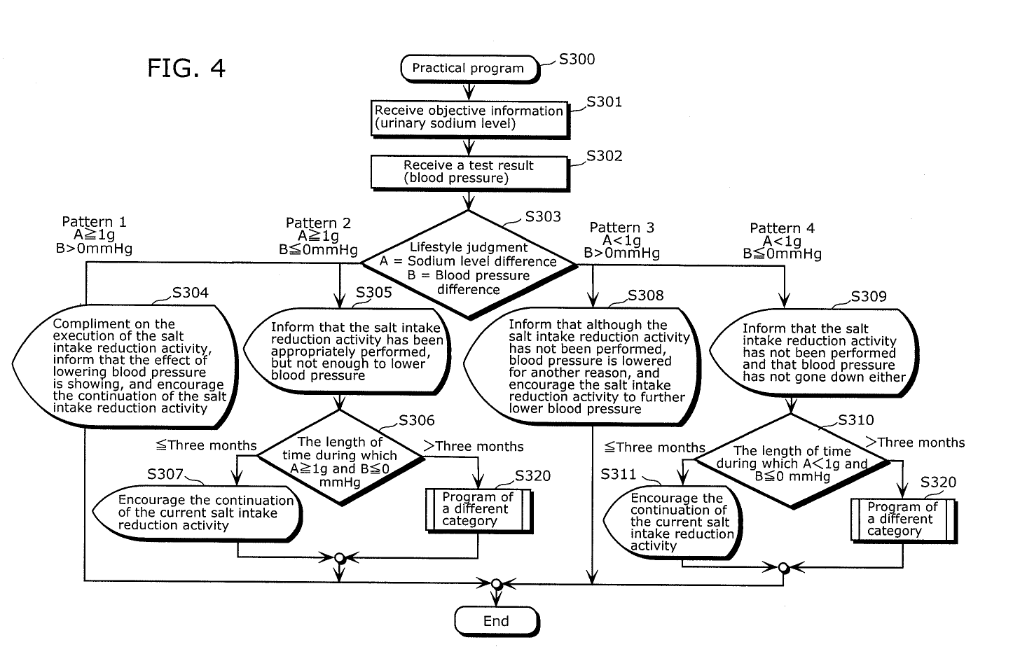

FIG. 4 is a flowchart showing processing details of the practical program (S300) of FIG. 2.

First, the objective information receiving unit 120 receives objective information (for example, an average daily urinary sodium level for the current month) of the subject (S301). This objective information is a measure which objectively represents the lifestyle (the state of salt intake, in this case here) of the subject. Moreover, the objective information receiving unit 120 reads the average daily urinary sodium level for the previous month from the test information storage unit 140, and then calculates a difference of the average values between the previous month and the current month. This difference in the urinary sodium level is referred to as “A”. “A” objectively represents whether or not the subject has appropriately performed the lifestyle improvement activity (in this case, the activity of salt intake reduction).

A=(average daily urinary sodium level [g/day] for the previous month)−(average daily urinary sodium level [g/day] for the current month) (2)

Generally speaking, it is possible to estimate the amount of salt intake from the amount of sodium excreted in the urine. This is because the total amount of urinary sodium for one day virtually agrees with the amount of salt intake of that day since most of the consumed salt is excreted in the urine. Thus, it can be judged whether or not the activity of “salt intake reduction” has been appropriate by: measuring the urinary sodium level every day; adding up the urinary sodium levels for one day; calculating the average daily urinary sodium level for one month; and then comparing this average level with the average level for the previous month.

Next, the test result receiving unit 110 receives the test result (the blood pressure value, in this case) of the subject from the subject (S302). Moreover, the test result receiving unit 110 reads the blood pressure value measured on the test day of the previous month from the test information storage unit 140, and then calculates a difference of the blood pressure values over a month by comparing the read blood pressure value with the received blood pressure value. This difference in blood pressure is referred to as “B”.

B=(blood pressure value measured on the test day of the previous month)−(blood pressure value measured on the test day of the current month) (3)

Next, the test result judgment unit 130 evaluates the lifestyle improvement activity on the basis of the above-mentioned calculated values A and B (S303). In regard to A, when A is 1 [g/day] or more, it is judged that “activity of salt intake reduction has been appropriately performed”. When the amount of difference is less than 1 [g/day], it is judged that “activity of salt intake reduction has not been appropriately performed”. In regard to B, when B>0 [mmHg], it is judged that the blood pressure shows a tendency to fall. When B≦0 [mmHg], it is judged that the blood pressure shows a tendency to rise. The evaluation of the lifestyle improvement activity is made on the basis of the combinations (four patterns) of the differences A and B (S303), and advice is presented corresponding to the combination (S304 to S320). The evaluation of the lifestyle improvement activity is described as follows.

(1) Pattern 1: the case where (A≧1 [g/day] and B>0 [mmHg])

The average urinary sodium level is decreased by 1 [g] or more as compared with that of the previous month, and the blood pressure value has gone down as well. From this, it can be judged that the subject has appropriately performed the activity of salt intake reduction based on the advice of the previous month and that the effect is shown as the decrease in blood pressure. Thus, in this case, advice that “compliments on the execution of the activity of salt intake reduction, informs that the effect of lowering blood pressure is showing, and encourages the continuation of the activity of salt intake reduction” is to be provided (S304).

(1) Pattern 2: the Case where (A≧1 [g/day] and B≦0 [m Hg])

Although the average urinary sodium level is decreased by 1 [g] or more as compared with that of the previous month, the blood pressure value has not gone down. From this, it can be judged that although the activity of salt intake reduction has been appropriately performed, the effect has yet to be seen. Thus, advice saying “The activity of salt intake reduction has been appropriately performed, but not enough to lower blood pressure” is given in this case. Moreover, when this state of Pattern 2 (A≧1 [g/day] and B≦0 mmHg) has lasted for three months or less, advice “encouraging the continuation of the current activity of salt intake reduction” is given (S307).

On the other hand, when the state of Pattern 2 (A≧1 [g/day] and B≦0 [mmHg]) has lasted for over three months, it is judged that the effect of lowering blood pressure cannot be expected from the present subject. Thus, the program is switched to a program of a different category (S320). Here, the program of the different category refers to a program of “weight reduction”, “exercise”, or “alcohol intake reduction”.

(3) Pattern 3: the Case where (A<1 [g/day] and B>0 [mmHg])

Although a decrease in the average urinary sodium level cannot be seen, the blood pressure value has gone down. From this, it can be judged that although the activity of salt intake reduction has not been performed, the blood pressure value seems to be lowered for another reason. Thus, in this case, advice that “informs that blood pressure is lowered although the activity of salt intake reduction has not been performed, and encourages the activity of salt intake reduction to further lower blood pressure” is provided (S308).

(4) Pattern 4: the case where (A<1 [g/day] and B≦0 [mmHg])

A decrease in the average urinary sodium level cannot be seen, and the blood pressure value has not gone down either. From this, it can be judged that the activity of salt intake reduction has not been appropriately performed. Thus, in this case, advice saying “the activity of salt intake reduction has not been performed and blood pressure has not gone down either” is presented (S309). Next, when the state of Pattern 4 has lasted for three months or less, advice that “encourages a further continuation of the activity of salt intake reduction” is provided (S311).

However, when the state of Pattern 4 has lasted for over three months, it is judged that it is difficult for the present subject to obtain the effect by continuing the current activity of salt intake reduction. Thus, the program is switched to a program of a different category (S320).

As described above, conventionally, it is often the case that only the blood pressure value is used for evaluating the activity of salt intake reduction. In this case, a distinction cannot be made between Pattern 1 and Pattern 3 and between Pattern 2 and Pattern 4, described in the present embodiment. When a distinction cannot be made between Pattern 2 and Pattern 4, the problem is that even when the advice details are changed, the subject cannot understand why the advice details are changed because the activity of salt intake reduction is not evaluated using an objective measure.

In the present embodiment, however, the advice is generated using the urinary sodium level which is the objective information objectively representing the lifestyle, in addition to using the blood pressure value which is the test result used for making a judgment as to whether or not the subject has hypertension. On account of this, the performance state of activity carried out by the subject in order to improve the lifestyle and its effectiveness can be grasped, meaning that the lifestyle improvement activity performed by the subject can be correctly evaluated. Accordingly, it becomes possible to provide appropriate advice corresponding to the performance state of the lifestyle improvement activity of the subject.

Moreover, a method of generating the advice in regard to the activity of salt intake reduction has been described in the present embodiment. As to the other advice categories, the lifestyle can also be evaluated using a blood pressure value and a measure which objectively represents whether or not the lifestyle is appropriate. For example, in the case of “weight reduction”, BMI is used in place of the urinary sodium level used in the case of the salt intake reduction. In the case of “exercise”, the number of walking steps is used in place of the urinary sodium level. In the case of “alcohol intake reduction”, the amount of alcohol intake is used in place of the urinary sodium level. By doing so, it is possible to generate advice in the same manner as described above.

### Second Embodiment

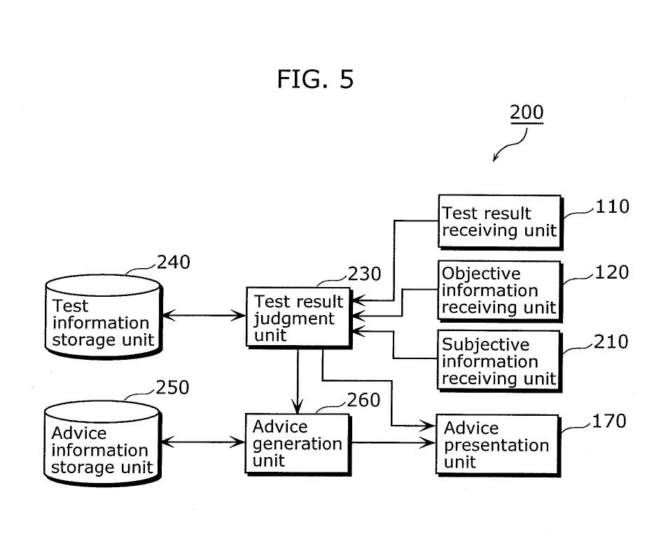

FIG. 5 is a block diagram showing a functional structure of a lifestyle improvement supporting apparatus 200 according to the present embodiment. The lifestyle improvement supporting apparatus 200 evaluates a lifestyle improvement activity and provides advice, based on: a test result (a blood pressure value, for example) directly used for diagnosing a lifestyle-related disease; objective information which is objective biological information (a urinary sodium level, for example) representing a lifestyle; and subjective information (a result of a clinical interview, for example) which subjectively represents a performance state of the lifestyle improvement activity. The lifestyle improvement supporting apparatus 200 includes a test result receiving unit 110, an objective information receiving unit 120, a subjective information receiving unit 210, a test result judgment unit 230, a test information storage unit 240, an advice information storage unit 250, an advice generation unit 260, and an advice presentation unit 170. It should be noted that functional components or steps in the present embodiment that are shared in common with the above first embodiment are designated by the same numerals as in the first embodiment and, therefore, the explanations are omitted here.

The subjective information receiving unit 210 is a keyboard or a mouse, for example, and receives subjective information (information representing a result of a clinical interview, for example) relating to the subject

The test result judgment unit 230 is, for example, a microcomputer which includes a RAM and a ROM storing a control program, and controls the overall lifestyle improvement supporting apparatus 200. Moreover, the test result judgment unit 230 stores: the test result received by the test result receiving unit 110; the objective information received by the objective information receiving unit 120; and the subjective information received by the subjective information receiving unit 210, into the test information storage unit 240 in association with the subject.

The test information storage unit 240 is a hard disk drive, for example, and stores the test result, the objective information, and the subjective information in association with each other, in response to an instruction from the test result judgment unit 130.

The advice information storage unit 250 is a hard disk drive, for example, and stores information needed for generating advice to be offered to the subject.

The advice generation unit 260 is, for example, a microcomputer which includes a RAM and a ROM storing a control program. On the basis of the test result received from the test result judgment unit 230, the advice generation unit 260 generates advice to be offered to the subject, using the data stored in the advice information storage unit 150.

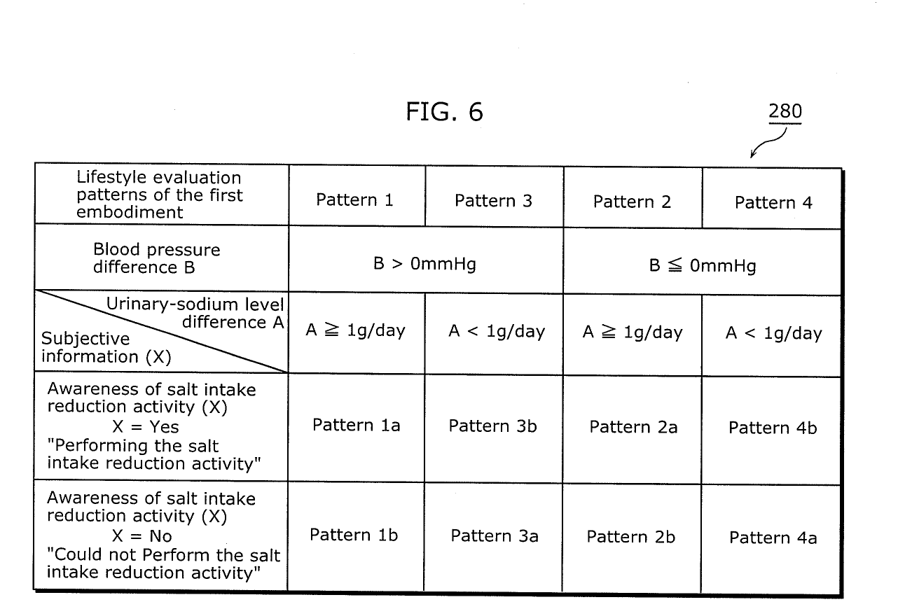

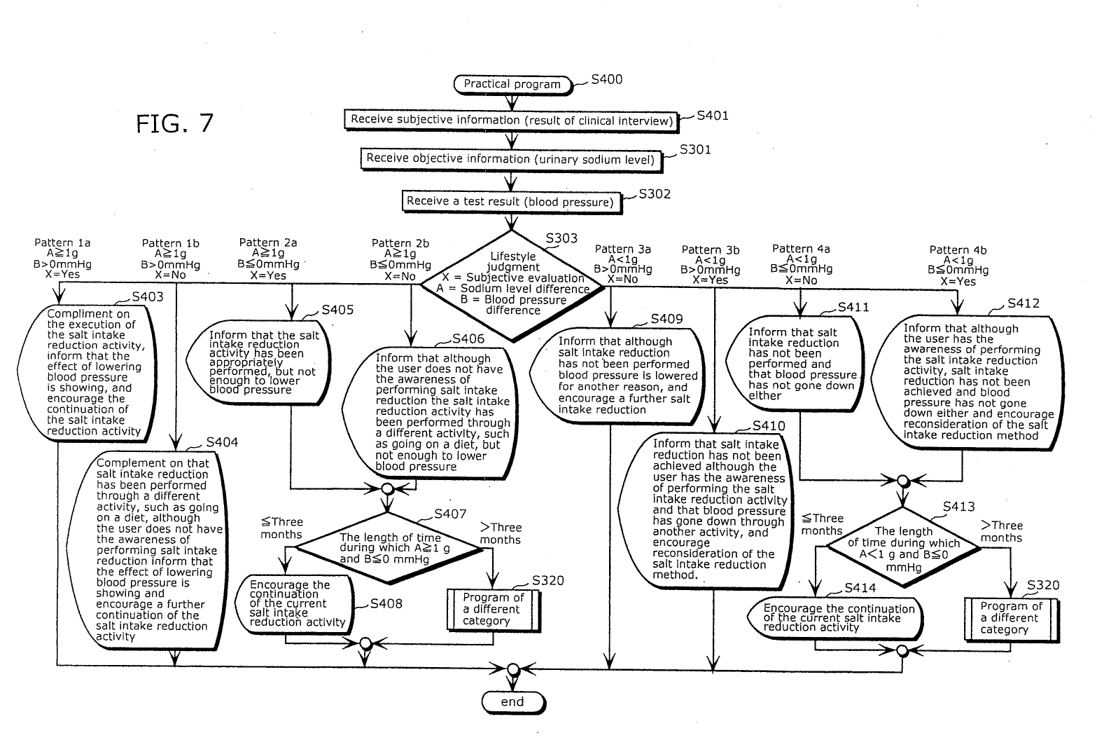

Next, an explanation is given about an operation performed by the lifestyle improvement supporting apparatus 200 configured as described above, with reference to FIGS. 6 and 7. It should be noted that the flowcharts of FIGS. 2 and 3 in the above first embodiment are used in the present embodiment as well. However, note that, in place of the practical program (S300), a practical program (S400) is executed in the present embodiment.

FIG. 7 is a flowchart showing processing details of the practical program (S400) performed by the lifestyle improvement supporting apparatus 200 according to the present embodiment.

First, the subjective information receiving unit 210 receives the subjective information (information representing a result of a clinical interview) of the subject (S401) as well as receiving the objective information and the test result (S301 and S302). The subjective information refers to information representing a result of an answer to a clinical question, such as a question as to whether or not the subject has performed the activity of salt intake reduction. This means that the subjective information represents a subjective result of the activity of salt intake reduction performed by the subject. This result is referred to as “X. When “X=Yes”, this means the subject thinks that the activity of salt intake reduction has been performed. When “X=No”, the subject does not think that the activity of salt intake reduction has been performed.

Next, the advice generation unit 260 generates the advice corresponding to a combination including the subjective information “X”, in addition to A and B described in the above first embodiment.

To be more specific, as in the case with the above first embodiment, when the urinary sodium level difference A is 1 [g/day] or more, it is judged that salt intake has been reduced. When the level difference is below 1 [g/day], it is judged that salt intake has not been reduced. Moreover, in regard to the blood pressure value difference B, when B>0 [mmHg], it is judged that the blood pressure shows a tendency to fall. When B≦0 [mmHg], it is judged that the blood pressure shows a tendency to rise. On the basis of the combination of the differences A and B and the answer result “X”, a judgment is made as to whether or not the lifestyle is appropriate (categorized into eight patterns) and then advice is presented corresponding to the state.

FIG. 6 is a diagram showing categorized patterns 280 of the advice generated by the lifestyle improvement supporting apparatus 200 according to the present embodiment.

Regarding the four patterns categorized in the above first embodiment, when there is no discrepancy between the subjective evaluation of the activity of salt intake reduction and the objective information of the activity of salt intake reduction (difference in the urinary sodium level), a subscript “a” is added to each pattern. On the other hand, when there is a discrepancy between the subjective evaluation of the activity of salt intake reduction and the objective information of the activity of salt intake reduction, a subscript “b” is added to each pattern. A method of the lifestyle evaluation is described as follows.

In the cases of Pattern 1a, Pattern 2a, Pattern 3a, and Pattern 4a, the difference in the urinary sodium level agrees with the subject's awareness of the activity of salt intake reduction. Thus, a comment is given on the details, and the corresponding advice as described in the above first embodiment is presented.

On the other hand, in the cases of Pattern 1b, Pattern 2b, Pattern 3b, and Pattern 4b, the difference in the urinary sodium level does not agree with the subject's awareness of the activity of salt intake reduction. Thus, advice that mentions the discrepancy and that also considers a correlation with the difference in blood pressure is generated and provided.

For example, in the case of Pattern 4b, although the subject thinks that the subject “has carried out the activity in order to reduce salt intake”, the urinary sodium level has not been decreased in reality. Thus, it is judged that the appropriate activity of salt intake reduction has not been correctly performed. In addition, the effect of lowering blood pressure has not been seen either.

Conventionally, the difference in the urinary sodium level is not evaluated and, for this reason, advice saying “Let's see how it works for a while, because the effect of lowering blood pressure has not yet been seen although the activity of salt intake reduction seems to have been performed” or “Switch to another lifestyle improvement category since the current activity of salt intake reduction seems to be ineffective” is generated for the subject belonging to this Pattern.

In the present embodiment, however, the urinary sodium level is evaluated in addition to the clinical interview, and the difference in the urinary sodium level is compared with the subject's awareness of the activity of salt intake reduction. With this, it can be noticed that the method employed by the subject to reduce salt intake is not appropriate. Accordingly, advice that includes a message encouraging reconsideration of the salt intake reduction method employed by the subject is generated.

In this way, by using the lifestyle improvement supporting apparatus 200 according to the present embodiment, it becomes possible to generate advice that corresponds more to the performance state of the lifestyle improvement activity carried out by the subject and to present the generated advice to the subject.

Although the subject has hypertension in the above embodiments, the present invention is not limited to this. The subject may be a patient having another lifestyle-related disease (such as hyperlipidemia or diabetes) other than hypertension; the subject may not be a patient but may be in a boundary zone of these diseases; and the subject may serve for the purpose of preventing these diseases. In this case, the order in which the advice categories are presented may be prepared for each of the diseases. For example, in the case of diabetes, limitation of sugar intake may be the first out of the advice categories.

Also, a user of the above-described lifestyle improvement supporting apparatus may be a medical staff, such as a doctor or a nurse. Then, a patient who is treated by the doctor may be a subject, and the lifestyle improvement supporting apparatus may be used for generating advice for this patient.

Moreover, it should be noted that, in the above embodiments, the test result, the subjective information, and the objective information are stored in a memory unit in association with a code identifying the subject and a date of measurement (or input).

Furthermore, in the above first and second embodiments, the advice for lifestyle improvement is generated using the transition state in the past month, with regard to fluctuations in the test value and in the objective information. However, the present invention is not limited to this. A measurement period and the number of reference measurements may be arbitrarily decided. For example, a difference in the test values measured this time and six month before may be used.

Also, in the above embodiments, each item is classified into two groups for evaluating the lifestyle improvement activity. However, the present invention is not limited to this. For example, the item may be classified into more than two groups, and advice may be provided corresponding to the group in the processing flow. As an example, for checking the fluctuation in the test value, the item may be classified into three groups: a blood-pressure increase group; a blood-pressure maintain group; and a blood-pressure decrease group. In this case, by corresponding to the more detailed state of the subject, more appropriate advice can be provided.

Moreover, the present invention can be configured as a lifestyle improvement supporting system including a mobile terminal and a lifestyle improvement supporting apparatus.

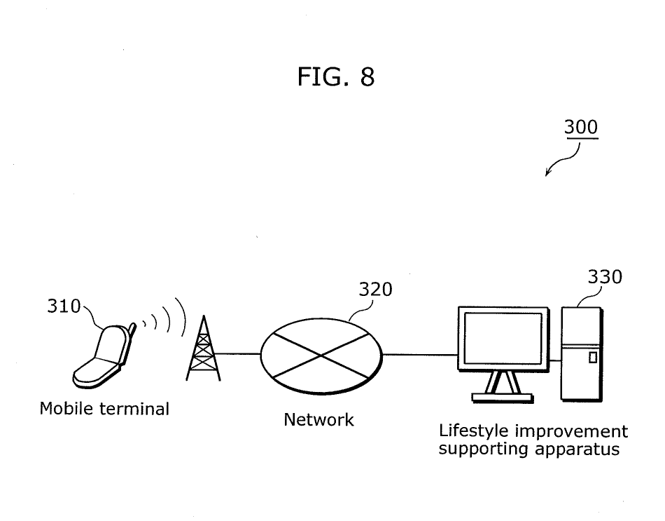

FIG. 8 shows an example of configuration of a lifestyle improvement supporting system 300 according to the present invention. A mobile terminal 310 shown in FIG. 8 includes the test result receiving unit 110, the objective information receiving unit 120, and the advice presentation unit 170 of the lifestyle improvement supporting apparatus 100 of the first embodiment. The mobile terminal 310 sends the necessary information to a lifestyle improvement supporting apparatus 330 via a network 320, receives advice sent from the lifestyle improvement supporting apparatus 330, and then presents the advice to the advice presentation unit 170. Moreover, the lifestyle improvement supporting apparatus 330 includes the test result judgment unit 130, the test information storage unit 140, the advice information storage unit 150, and the advice generation unit 160. The lifestyle improvement supporting apparatus 330 generates advice using the necessary information received from the mobile terminal 310, and then sends the advice to the mobile terminal 310.

### INDUSTRIAL APPLICABILITY

The present invention can provide a lifestyle improvement supporting apparatus and a lifestyle improvement supporting method which can offer appropriate advice corresponding to a performance state of lifestyle improvement carried out by a subject, and thus useful for prevention and treatment of lifestyle-related diseases.

1. A lifestyle improvement supporting apparatus, comprising:
a test result receiving unit operable to receive a test result which is used for diagnosing a lifestyle-related disease of a subject;
an objective information receiving unit operable to receive objective information which objectively represents a lifestyle of the subject; and
an advice generation unit operable to generate advice corresponding to a combination of the received test result and the received objective information, the advice being used for improving the lifestyle.

2. The lifestyle improvement supporting apparatus according to claim 1, further comprising
a subjective information receiving unit operable to receive subjective information which subjectively represents a performance state of an activity performed by the subject to improve the lifestyle,
wherein said advice generation unit is further operable to generate advice corresponding to a combination of the received test result, the received objective information, and the received subjective information, the advice being used for improving the lifestyle.

3. The lifestyle improvement supporting apparatus according to claim 2,
wherein: the lifestyle-related disease is hypertension; the test result is a blood pressure value of the subject; the objective information is a urinary sodium level of the subject; and the subjective information is a result of a clinical interview given to the subject, and
said advice generation unit is operable to generate the advice corresponding to a combination of the blood pressure value, the urinary sodium level, and the result of the clinical interview, the blood pressure value and the urinary sodium level both being measured in a predetermined period of time.

4. The lifestyle improvement supporting apparatus according to claim 1, further comprising
a test information storage unit operable to store the test result and the objective information,
wherein said test result receiving unit is operable to read a past test result stored in said test information storage unit, and to calculate a difference based on a comparison between the received test result and the past test result,
said objective information receiving unit is operable to read past objective information stored in said test information storage unit, and to calculate a difference based on a comparison between the received objective information and the past objective information, and
said advice generation unit is operable to generate the advice corresponding to a combination of the difference in the test results and the difference in the objective information, the advice being used for improving the lifestyle.

5. The lifestyle improvement supporting apparatus according to claim 1, further comprising
a test result judgment unit operable to judge, using the received test result, whether or not the lifestyle needs to be improved.

6. A lifestyle improvement supporting method, comprising:
a test result receiving step of receiving a test result which is used for diagnosing a lifestyle-related disease of a subject;
an objective information receiving step of receiving objective information which objectively represents a lifestyle of the subject; and
an advice generation step of generating advice corresponding to a combination of the received test result and the received objective information, the advice being used for improving the lifestyle.

7. A program used by a lifestyle improvement supporting apparatus, said program causing a computer to execute:
a test result receiving step of receiving a test result which is used for diagnosing a lifestyle-related disease of a subject;
an objective information receiving step of receiving objective information which objectively represents a lifestyle of the subject; and
an advice generation step of generating advice corresponding to a combination of the received test result and the received objective information, the advice being used for improving the lifestyle.

8. The lifestyle improvement supporting apparatus according to claim 2, further comprising
a test information storage unit operable to store the test result and the objective information,
wherein said test result receiving unit is operable to read a past test result stored in said test information storage unit, and to calculate a difference based on a comparison between the received test result and the past test result,
said objective information receiving unit is operable to read past objective information stored in said test information storage unit, and to calculate a difference based on a comparison between the received objective information and the past objective information, and
said advice generation unit is operable to generate the advice corresponding to a combination of the difference in the test results and the difference in the objective information, the advice being used for improving the lifestyle.

9. The lifestyle improvement supporting apparatus according to claim 2, further comprising
a test result judgment unit operable to judge, using the received test result, whether or not the lifestyle needs to be improved.
